(19) United States
(12) Patent Application Publication
(10) Pub. No.: US 2007/0099166 A1
(43) Pub. Date: May 3, 2007

(54) Systems and methods of training management using peer groups

(76) Inventors: Marc Moesges, Heidelberg (DE); Holger Bohle, Walldorf (DE); Marcus Philipp, Dielheim (DE); Stefan Schuessler, Heidelberg (DE)

Correspondence Address: RICHARD F. JAWORSKI;Cooper & Dunham LLP, 1185 Avenue of the Americas, New York, NY, 10036, US

(21) Appl. No.: 11/262,870

(22) Filed: Oct. 31, 2005

(51) Int. Cl. G09B 3/00

(52) U.S. Cl. 434/350; 434/362

(57) ABSTRACT

A training management system includes a mechanism for defining a time-dependent group of learners, a mechanism for defining a responsible party who is responsible for the time-dependent group of learners and a mechanism for defining at least one common objective for each of the group of learners.

### BACKGROUND OF THE DISCLOSURE

1. Field of the Disclosure

The present disclosure relates generally to training management and in particular, to systems and methods of training management using peer groups.

2. Description of the Related Art

Employee growth can be important to a company. Companies have a vested interest in seeing to it that employees stay up to date on new technologies and ideas and also in seeing employees rise through the ranks to assume managerial rolls in a timely and efficient manner. To achieve these and other goals, it is important for a company to educate its employees. Many companies send a great deal of time and money attempting to properly train and keep employees up to date for their present job duties as well as for continued growth. Companies may provide hands on training while on the job. Companies may also provide other formal training including classroom and/or web based instruction in actual or virtual class rooms.

Many companies use electronic learning systems (ELS) to train employees. Electronic learning systems provide users with the ability to access course content directly from their computers, without the need for intermediaries, such as teachers, tutors, and the like. Such computer-based systems have proven attractive for precisely this reason.

Systems exist which allow users to book ELS training electronically. These conventional systems include courses, which may only be taken as an individual course and courses which may be taken as part of a curriculum.

However, to take full advantage of each employee's experience and training, it is important for the company to arrange for appropriate individual training and to keep track of that information for each employee. This can be a time consuming and difficult task, particularly in a company having hundreds or thousands of employees.

### SUMMARY

This application describes tools (in the form of methodologies, apparatuses, and systems) for training management. The tools may be embodied in one or more computer programs stored on a computer readable medium or program storage device and/or transmitted in the form of a computer data signal in one or more segments via a computer network or other transmission medium.

A training management system, comprises a mechanism for defining a time-dependent group of learners, a mechanism for defining a responsible party who is responsible for the time-dependent group of learners and a mechanism for defining at least one common objective for each of the group of learners.

A method of training management, comprises defining a time-dependent group of learners, defining a responsible party who is responsible for the time-dependent group of learners and defining at least one common objective for each of the group of learners.

A computer recording medium including computer executable code capable of performing training management, comprises code for defining a time-dependent group of learners, code for defining a responsible party who is responsible for the time-dependent group of learners and code for defining at least one common objective for each of the group of learners.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram of an exemplary computer system capable of implementing the methods and systems of the present disclosure;

FIG. 2 is a block diagram of a training system according to an embodiment of the present disclosure;

FIG. 3 shows elements making up a peer group according to an embodiment of the present disclosure;

FIG. 4 is a block diagram showing a collaboration room according to an embodiment of the present disclosure;

FIG. 5 is a block diagram showing the configuration and operations associated with a peer group according to an embodiment of the present disclosure;

FIG. 6 shows data that may be provided for defining a peer group according to an embodiment of the present disclosure; and

FIG. 7 is a flow chart showing steps for creating a peer group according to an embodiment of the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

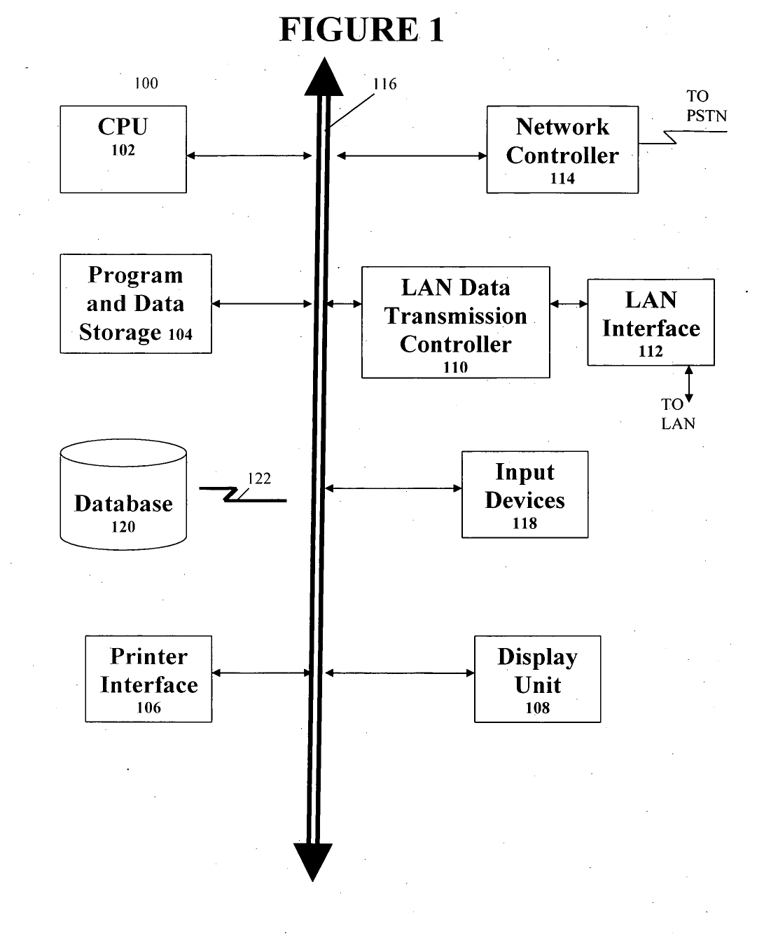

FIG. 1 shows an example of a computer system 100 which may implement the methods and systems of the present disclosure. The systems and methods of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary. The specific embodiments described herein are illustrative, computer system(s) as referred to herein may include(s) one or more individual computers, servers, computing resources, networks, etc., and many variations can be introduced on these embodiments without departing from the spirit of the disclosure or from the scope of the appended claims.

For a company to achieve certain aims or objectives, employees (learners) may be required to participate in various training exercises including courses and curriculum. It would be convenient and efficient if learners could be grouped by qualifications and/or experience. This would allow management to oversee learner training and to more effectively deploy qualified personnel in appropriate positions in a timely and efficient manner. According to embodiments of the present disclosure, to achieve these and other goals, learners may be grouped together into “peer groups.”

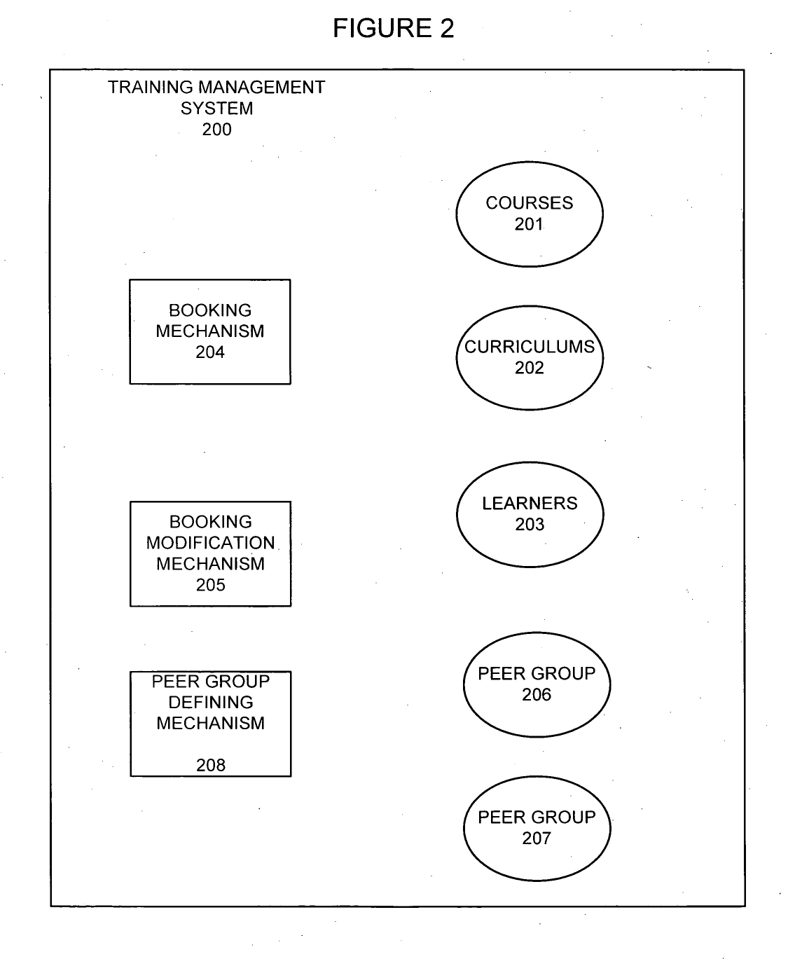

FIG. 2 shows a training management system 200. The training management system 200 is capable of managing a set of courses 201, a set of curriculums 202, one or more learners 203, booking mechanism 204, booking modification mechanism 205, a peer group defining mechanism 208 and one or more peer groups 206, 207. Peer group defining mechanism 208 allows a party to define various aspects of a peer group including, for example, a group of learners associated with the peer group, a party responsible for the peer group, common objectives of the peer group, etc. The peer group defining mechanism may be in the form of a software application that provides one or more graphic user interfaces (GUI) enabling a party to enter information used to create the peer group.

A course constitutes a training that provides instruction about a particular topic. Associated with each course is information specifying course constraints, such as course start and end dates, course prerequisites, and qualifications imparted by the course.

The set of courses 201 can include different types of courses including web-based courses, classroom courses, and on-the-job courses. An on-the-job course is a course that includes one or more work assignments and a required time interval for completing the work assignments. A classroom course is a live course that is given by an instructor in a fixed location at a fixed time. A web-based course is a course that is delivered over the Internet. With web-based courses, there is usually not a fixed location and there often is not a fixed time either. Examples of web-based courses include on-line tutorial programs and presentations.

A curriculum 202 is a group of two or more courses selected from a set of courses managed by the system. Within the group, the courses are arranged in a sequence that determines the order in which the courses should be taken. Associated with each curriculum is information specifying the curriculum constraints, such as curriculum start and end dates, curriculum prerequisites, and qualifications imparted by completion of the curriculum.

A learner 203 is a user of the system that is authorized to book courses or curriculums managed by the curriculum management system. For each learner, the system can maintain a learner profile that keeps track of the learner's bookings and the qualifications earned by the learner.

Booking mechanism 204 is used to allow learners 203 and peer groups 206, 207 to schedule courses to be taken. Booking modification mechanism 205 allows bookings to be modified by cancellation, re-booking or follow up.

Peer groups 206, 207 are time-dependent groupings of learners that share common goals. The composition of a peer group can be arranged flexibly using different criteria so that learners fitting specific criteria for the peer group can be found. For example, peer groups can be arranged by organizational criteria and/or by personal criteria.

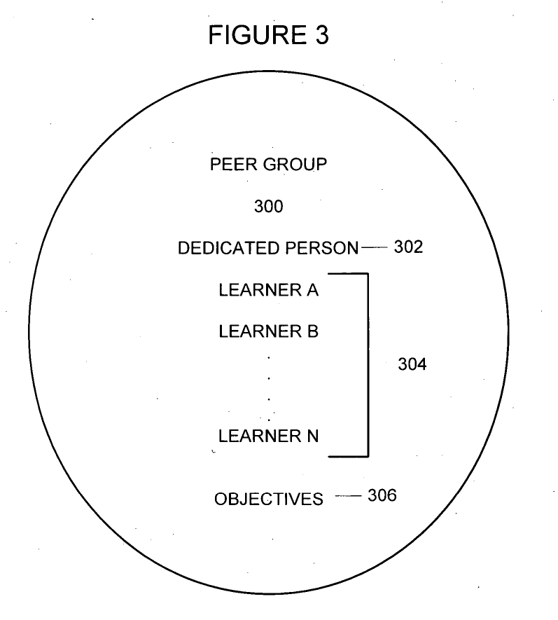

As shown in more detail in FIG. 3, a peer group 300 can have at least one dedicated person 302 assigned to it who is responsible for the peer group and one or more members or learners 304. Dedicated person 302 is responsible for organizing the peer group, selecting common objectives 306 for the peer group and otherwise seeing to it that the objectives 306 of the peer group are met in a timely and efficient manner.

It may be important that members of a peer group communicate with each other to exchange information for achieving the objectives of the peer group. Although the level of communication may vary depending on the type of peer group as will be described later below, in general, learners 304 in a peer group 300 are able to communicate with each other and with the dedicated person 302 responsible for the peer group 300 in one or more collaboration rooms.

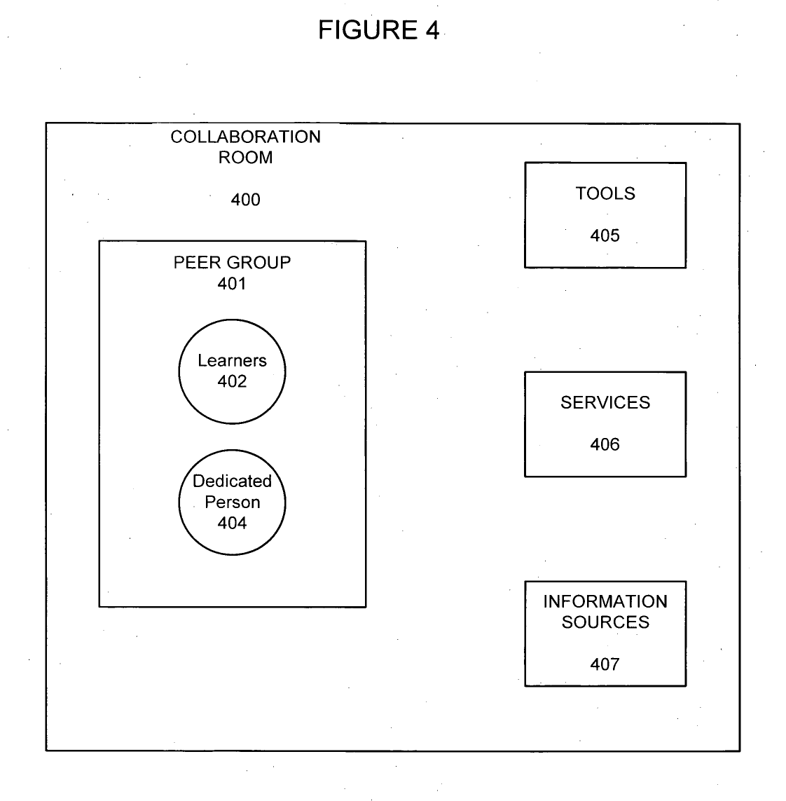

As shown in FIG. 4, collaboration rooms 400 may be used as a communication tool allowing the learners 402 and the dedicated person 404 responsible for the peer group 401 to communicate effectively. A collaboration room 400 is used to create, maintain, and manage virtual work spaces for the peer group 401. The whole peer group 401 or individual learners 402 in the peer group may be invited to collaboration room 400. Regardless of where they are physically located, learners 402 can be provided access rights to the collaboration room 400 to share knowledge and ideas and to work in a team-oriented environment. Tools 405, services 406 and information sources 407 may be provided in the collaboration room to aid in achieving the peer group's objectives and are shared among those in the collaboration room 400 from a common point of access such as a portal. For example, collaboration room 400 allows learners in peer group 401 to edit and publish information to all members of the peer group. The collaboration room 400 can be set up with a calendar and synchronized with personal calendars of learners 402 and/or dedicated person 404 showing times or dates by which courses are to be taken, etc. Learners 402 can be automatically be prompted when a course deadline is approaching. Learners 402 can also arrange and schedule online meetings with other learners and/or dedicated person 404 to discuss matters related to achieving the objectives of the peer group 401.

There are various types of peer groups that can be formed. For example, a peer group can be static or dynamic. A static peer group is a group of learners who are physically related to the peer group. A dynamic peer group is one in which learners are not physically linked to the peer group and, instead, are determined at runtime or the time of actual formation of the peer group. As noted above, criteria for finding learners of a peer group can include organizational criteria such as, for example, “holders of a certain position,” “members of a certain organizational unit,” etc. and personal criteria such as, for example, “persons of a certain gender,” and/or “persons within a certain age range,” etc. Accordingly, the learners in a dynamic peer group can vary depending on a date determined by the party creating the peer group. The criteria for finding the learners of a dynamic peer group can be stored in an infotype. Infotype is a set of data grouped together according to subject matter that enables a party to process employee data in an effective structure in accordance with business requirements.

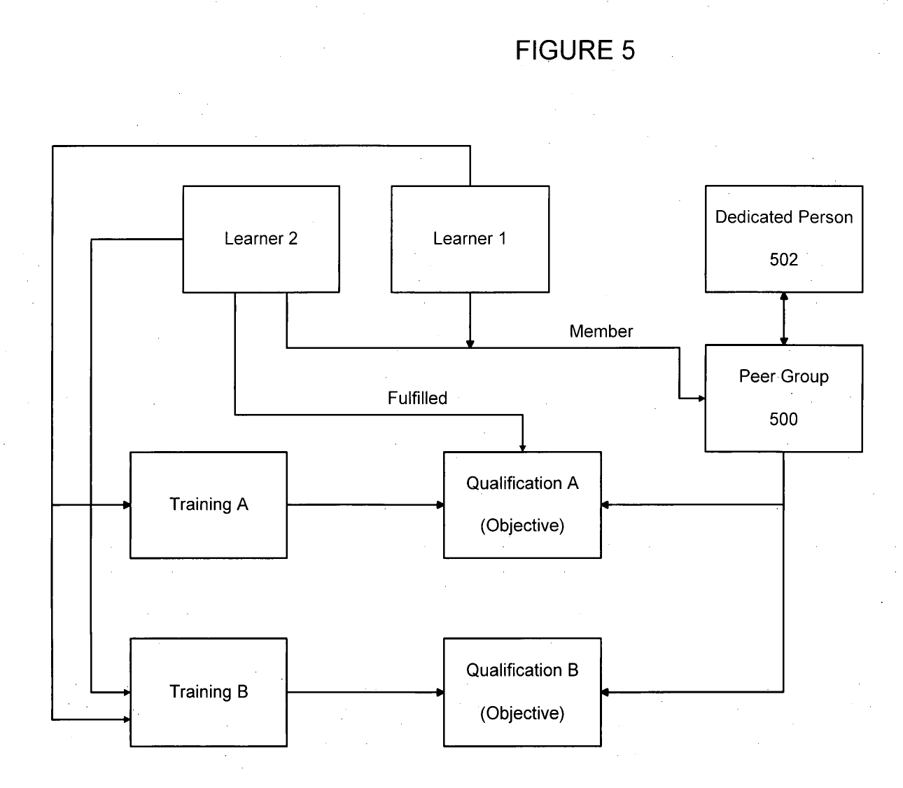

FIG. 5 shows an example of the configuration and operations associated with a static peer group, according to an embodiment of the present disclosure. Peer group 500 includes two members namely learner 1 and learner 2. Of course, peer group 500 can include any number of learners. Peer group 500 has two objectives namely qualification A and qualification B. Accordingly, learner 1 and learner 2 are required to achieve qualification A and qualification B. Dedicated person 502 is responsible for peer group 500.

In this example, learner 1 has not yet fulfilled any of the objectives of peer group 500. That is, learner 1 has not yet received qualification A or qualification B. Accordingly, learner 1 is required to take training A and training B. Upon completion of training A, learner 1 will achieve qualification A. Upon completion of training B, learner 1 will achieve qualification B. On the other hand, learner 2 has already fulfilled qualification A and only needs to fulfill qualification B. Accordingly, learner 2 is required to take training B. Upon completion of training B, learner 2 will achieve qualification B. It should be noted that training A and training B may be individual courses or curriculums or some other form of training.

Dynamic peer groups are arranged in a similar manner to the static peer groups shown in FIG. 5. However, as described above, with dynamic peer groups, the learners are determined when the peer group is formed at runtime or at some other point in time chosen by the party forming the peer group, based on the criteria chosen.

The present system is capable of keeping track of information indicating the knowledge each of the learners presently has compared to objectives of the peer group as well as what courses each of the learners still has to attend to reach the stated objectives of the peer group. Dedicated person 502 may be provided with periodic reports of this information allowing dedicated person 502 to determine the status of each participant's progress toward achieving the objectives of the peer group. The periodic report can be in the form of an email, for example. Based on the periodic report, dedicated person 502 can contact the participants, if necessary, to motivate them towards achieving the goals.

Peer groups can be flagged with an attribute indicating whether the peer group is “public,” “restricted,” or “private.” In a public peer group, a learner can register himself for the peer group and the list of members is visible to any interested parties. In a restricted peer group, an administrator or dedicated party assigns learners to the peer group. In the restricted peer group, the list of members of the peer group is visible to any interested parties. In a private peer group, only an administrator or dedicated party responsible for the peer group can assign a learner to the peer group. In the private peer group, the list of members of the peer group is not visible to anyone other than the administrator or dedicated party that created the peer group.

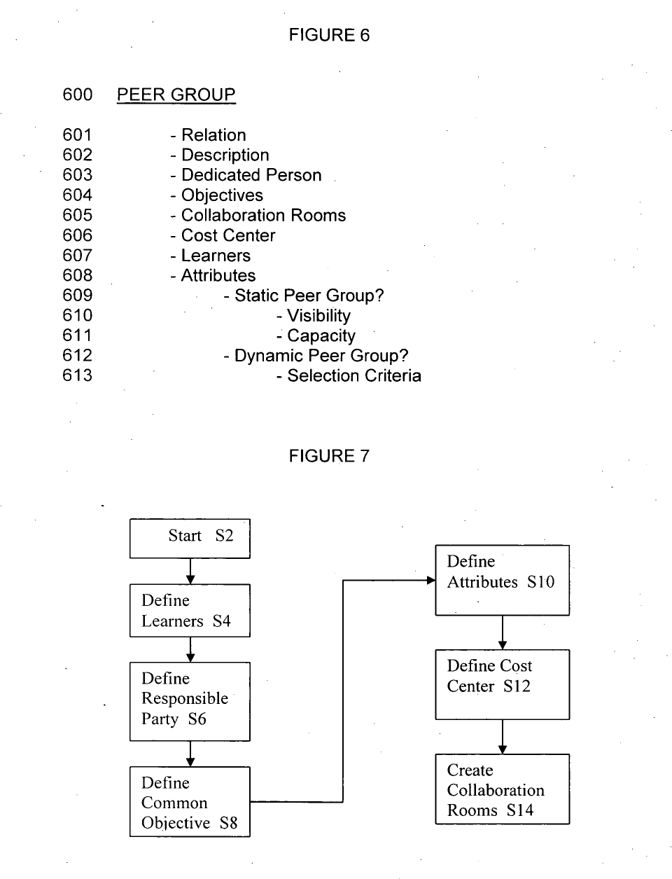

A database may be provided which can supply various types of information on existing peer groups as shown in FIG. 6. This allows parties to find peer groups they are interested in. The information for each peer group 600 can include relation information 601 which describes the relation to peer group groups. This information can be in the form of a file that may be used to determine the structure of existing peer groups. Another type of information that can be provided is a description 602 of the peer group. This is text used to describe the peer group. The description 602 may include, for example, information describing the objectives of the peer group. The name of the dedicated person 603 assigned to the peer group may also be provided. This person may also be referred to as the head of the peer group Of course, more than one dedicated person may be assigned to the peer group in which case this information can include the names of each of the dedicated parties assigned to the peer group. As noted above, the head of the peer group creates and maintains the peer group and communicates with its members. Information identifying the objectives 604 of the peer group may be provided. It should be noted that all objectives are related to each other with a logical AND. Logical OR and NOT between objectives are not allowed. Collaboration room identifying information 605 may be provided for identifying one or more collaboration rooms associated with the peer group. Cost center information 606 for the peer group may also be provided. Cost center is used for accounting/budgeting purposes to define the peer group as a cost-accounting entity or place at which the costs associated with achieving the objectives of the peer group can be charged. For example, the cost center information can be used as the receiver cost center for N.N (no name) bookings of a peer group. For example, if a peer group is booked for a course as 5 no name bookings, the peer group can be charged for the costs. Learner information 607 identifies the learners in the peer group. The learner information 607 can be in the form of the learners' names, employee numbers, social security numbers, etc. Since the learner information is not known until runtime or when the peer group is formed for a dynamic peer group, the learner information is provided here only if the peer group is static. Attribute information 609 may also be provided. For static peer groups 609, the attribute information may include visibility information 610 indicating whether the learner information is visible. As noted above, visibility depends on whether the peer group is public, protected or private. Capacity information 611 may also be provided indicating a maximum number of learners the peer group can have. Attribute information for dynamic peer groups 612 can include the selection criteria 613 used for selecting participants in the peer group. Dynamic peer groups generally have no set capacity limits, since the number of participants will depend on the number of people found that match the selection criteria 613.

Thus, peer groups can be set up as shown in FIG. 7. Upon start of creation of the peer group (Step S2), the learners are defined (Step S4). When creating a static peer group, this may involve, for example, actually choosing the learners from among lists of employees or adding employees to the peer group based on the employee's decision to join the peer group. When creating a dynamic peer group, this may involve setting up one or more forms of criteria which at run time are used for selecting appropriate employees to join the peer group as learners. The process also involves defining one or more responsible parties (Step S6) and defining one or more common objectives (Step S8) that the learners in the peer group are to achieve. If desired, attributes (visibility, capacity, etc.) may be defined (Step S10), cost center may be defined (Step S12) and one or more collaboration rooms may be created (Step S14).

It should be noted that peer groups are not hierarchical objects. In addition, peer groups behave like a selection in the daily business. For example, the peer group may be used as an entity to cancel, rebook, prebook, replace and follow up with courses that are to be taken to meet the objectives of the peer group. Courses are “booked” meaning that the courses are scheduled to be taken by a learner. Bookings can occur through a variety of methods. For example, a course may be booked electronically from a remote learning station or via other methods such as by telephone.

Once booking of a course or curriculum for the peer group has been made, it can be modified by cancellation, re-booking or follow up. Cancellation removes a booking from the schedule of bookings. Re-booking shifts or reschedules a booking to a different start date. Follow-up is a bookkeeping operation that is performed by an administrator once a course or a curriculum has ended. During follow-up, any qualifications that are imparted by the course or curriculum are transferred to a profile of the learner that successfully completed the course of curriculum. This information can also be provided to the party responsible for the peer group in the form of a report. The party responsible for the peer group and/or the learners in the peer group can also enter a learning portal to retrieve information regarding scheduled dates of training for which the learner is prebooked.

The learners of a peer group can be booked individually or peer groups can be booked as group participants. For example, a peer group can be booked for a course as 5 no names (N.N.) In the case of N.N. bookings, the cost center of the peer group is used for the cost transfer so that the peer group will be charged for the bookings. If desired, the N.N. bookings of a peer group can later be replaced by bookings of actual members (learners) of the peer group. The booking of a learner as a peer group member is not persistent. That is, information is not stored in participation data for the course or curriculum that the booking was made via a peer group.

The training management system can be implemented in digital electronic circuitry, or in computer hardware, firmware, software, or in combinations of them. The training management system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the training management system can be performed by one or more programmable processors executing a computer program to perform functions of the disclosure by operating on input data and generating output. Method steps can also be performed by, and apparatus of the disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, the disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The training management system can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the disclosure, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

The training management system has been described in terms of particular embodiments. Other embodiments are within the scope of the following claims. For example, the training management system can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

The present disclosure may be conveniently implemented using one or more conventional general purpose digital computers and/or servers programmed according to the teachings of the present specification. Appropriate software coding can readily be prepared by skilled programmers based on the teachings of the present disclosure. The present disclosure may also be implemented by the preparation of application specific integrated circuits or by interconnecting an appropriate network of conventional component circuits.

Numerous additional modifications and variations of the present disclosure are possible in view of the above-teachings. It is therefore to be understood that within the scope of the appended claims, the present disclosure may be practiced other than as specifically described herein.

What is claimed is:

1. A training management system, comprising:
a mechanism for defining a time-dependent group of learners;
a mechanism for defining a responsible party who is responsible for the time-dependent group of learners; and
a mechanism for defining at least one common objective for each of the group of learners.

2. The training management system as recited in claim 1, wherein the time-dependent group of learners is static.

3. The training management system as recited in claim 1, wherein the time-dependent group of learners is dynamic.

4. The training management system as recited in claim 3, wherein the time-dependent group of learners is chosen based on different criteria.

5. The training management system as recited in claim 4, wherein the different criteria comprise at least one of organizational criteria and personal criteria.

6. The training management system as recited in claim 5, wherein the organizational criteria comprises requiring learners to be at least one of a) holders of a certain position and b) members of a certain organizational group.

7. The training management system as recited in claim 5, wherein the personal criteria comprises requiring learners to be at least one of a) members of a certain gender and b) persons of a certain age range.

8. The training management system as recited in claim 1, wherein each learner can register themselves as one of the group of learners and wherein each learner can see who other learners are in the group of learners.

9. The training management system as recited in claim 1, wherein the responsible party has to register each learner as one of the group of learners and wherein each learner can see who other learners are in the group of learners.

10. The training management system as recited in claim 1, wherein the responsible party has to register each learner as one of the group of learners and wherein each learner can not see who other learners are in the group of learners.

11. A method of training management, comprising:
defining a time-dependent group of learners;
defining a responsible party who is responsible for the time-dependent group of learners; and
defining at least one common objective for each of the group of learners.

12. The method of training management as recited in claim 11, wherein the time-dependent group of learners is static.

13. The method of training management as recited in claim 11, wherein the time-dependent group of learners is dynamic.

14. The method of training management as recited in claim 13, wherein the time-dependent group of learners is chosen based on different criteria.

15. The method of training management as recited in claim 14, wherein the different criteria comprise at least one of organizational criteria and personal criteria.

16. The method of training management as recited in claim 15, wherein the organizational criteria comprises requiring learners to be at least one of a) holders of a certain position and b) members of a certain organizational group.

17. The method of training management as recited in claim 15, wherein the personal criteria comprises requiring learners to be at least one of a) members of a certain gender and b) persons of a certain age range.

18. The method of training management as recited in claim 11, wherein each learner can register themselves as one of the group of learners and wherein each learner can see who other learners are in the group of learners.

19. The method of training management as recited in claim 11, wherein the responsible party has to register each learner as one of the group of learners and wherein each learner can see who other learners are in the group of learners.

20. The method of training management as recited in claim 11, wherein the responsible party has to register each learner as one of the group of learners and wherein each learner can not see who other learners are in the group of learners.

21. A computer recording medium including computer executable code capable of performing training management, comprising:
code for defining a time-dependent group of learners;
code for defining a responsible party who is responsible for the time-dependent group of learners; and
code for defining at least one common objective for each of the group of learners.

22. The computer recording medium as recited in claim 21, wherein the time-dependent group of learners is static.

23. The computer recording medium as recited in claim 21, wherein the time-dependent group of learners is dynamic.

24. The computer recording medium as recited in claim 23, wherein the time-dependent group of learners is chosen based on different criteria.

25. The computer recording medium as recited in claim 24, wherein the different criteria comprise at least one of organizational criteria and personal criteria.

26. The computer recording medium as recited in claim 25, wherein the organizational criteria comprises requiring learners to be at least one of a) holders of a certain position and b) members of a certain organizational group.

27. The computer recording medium as recited in claim 25, wherein the personal criteria comprises requiring learners to be at least one of a) members of a certain gender and b) persons of a certain age range.

28. The computer recording medium as recited in claim 21, wherein each learner can register themselves as one of the group of learners and wherein each learner can see who other learners are in the group of learners.

29. The computer recording medium as recited in claim 21, wherein the responsible party has to register each learner as one of the group of learners and wherein each learner can see who other learners are in the group of learners.

30. The computer recording medium as recited in claim 11, wherein the responsible party has to register each learner as one of the group of learners and wherein each learner can not see who other learners are in the group of learners.
